(19) United States
(12) Patent Application Publication
(10) Pub. No.: US 2009/0112919 A1
(43) Pub. Date: Apr. 30, 2009

(54) METHOD AND SYSTEM TO MODEL AND CREATE A VIRTUAL PRIVATE DATACENTER

(75) Inventor: Kristof De Spiegeleer, Knokke-Heist (BE)

Correspondence Address: DLA PIPER LLP (US ), 2000 UNIVERSITY AVENUE, EAST PALO ALTO, CA, 94303-2248, US

(73) Assignee: Qlayer NV, Lochristi (BE)

(21) Appl. No.: 12/258,306

(22) Filed: Oct. 24, 2008

Related U.S. Application Data
(60) Provisional application No. 60/982,728, filed on Oct. 26, 2007.

(51) Int. Cl. G06F 17/30

(52) U.S. Cl. 707/102; 707/100; 707/E17.001

(57) ABSTRACT

A virtual private datacenter system and method are provided. A method for capacity planning of a virtual private datacenter and a method for chargeback for use of the virtual private datacenter also are disclosed.

### PRIORITY CLAIM

This application claims the benefit and priority, under 35 USC 119(e) and 120, to U.S. Provisional Patent Application Ser. No. 60/982,728, filed on Oct. 26, 2007 and entitled “Method and System to Model and Create a Virtual Private Datacenter”, the entirety of which is incorporated herein by reference.

### FIELD

The disclosure relates to a virtual private data center system and method.

### BACKGROUND

Known systems may provide a web interface to manage servers, located in a datacenter, remotely. In addition, some web interface may allow the creation of virtual servers remotely. However, the typical systems are always limited to the creation of individual servers, not a whole environment comprising servers, appliances, network infrastructure, storage devices and applications. Thus, it is desirable to provide a virtual datacenter system and method and it is to this end that the disclosure is directed.

### BRIEF DESCRIPTION OF THE DRAWINGS

FIG. 1 illustrates an example of a virtual private data center system; and

FIG. 2 illustrates an example of a graphical user interface for the virtual private data center system.

### DETAILED DESCRIPTION OF ONE OR MORE EMBODIMENTS

The disclosure is particularly applicable to a web-based implementation of the system and method and it is in this context that the system and method will be described. It will be appreciated that variations and modifications of the system and method can be made, such as using different technology implementations or different methodologies and still be within the scope of the system and method.

A system and method to model a virtual private datacenter (VPDC) and map the VPDC to physical resources in a datacenter are disclosed. A method is also disclosed to perform chargeback for usage of the VPDC. Furthermore, a system and method are disclosed to create and change the VPDC and its characteristics. First, an example of a virtual private datacenter system is described.

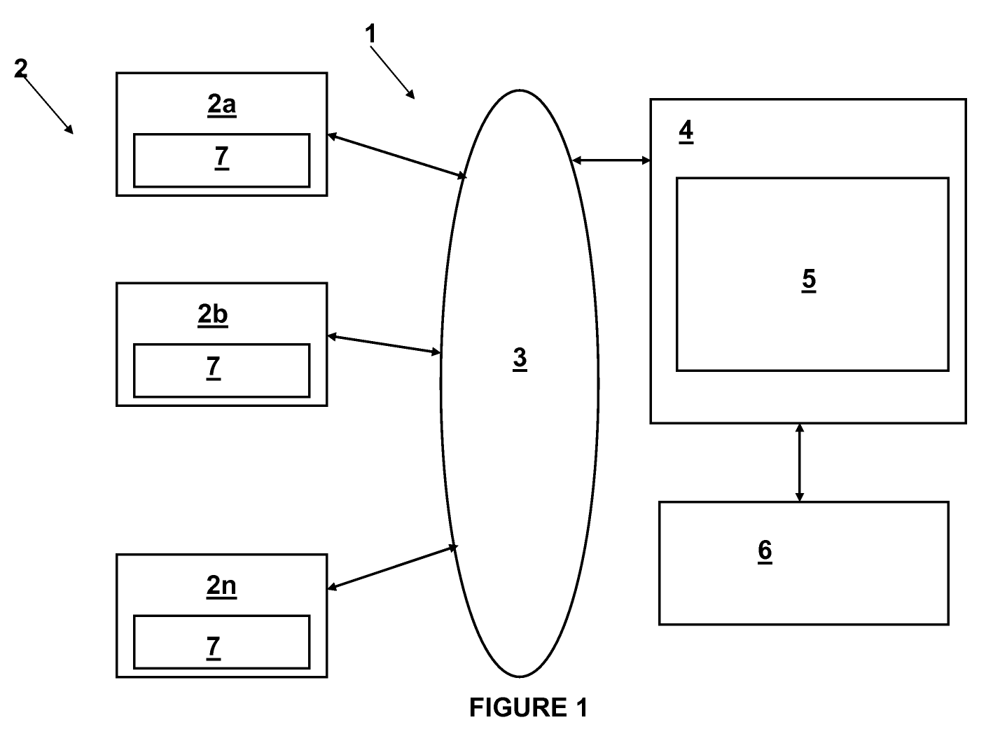

FIG. 1 illustrates an example of a virtual private data center system 1 wherein the virtual private datacenter is one or more virtual appliances that can be “rented” by a user through a chargeback (described below in more detail) and the virtual appliances are mapped onto physical resources that implement the virtual private datacenter. The system allows a user to create and change the VPDC and its characteristics. Using the system, a user can select virtual appliances that can be added to the VPDC. Furthermore, using the system, a user can interconnect virtual appliances using various types of interconnections.

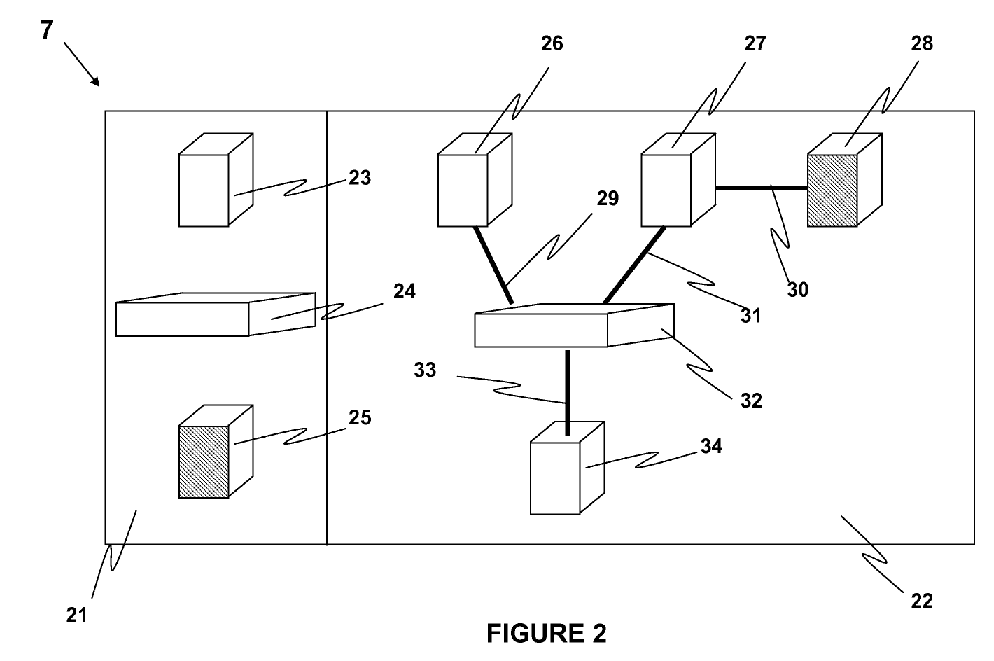

In one embodiment of the system, the system has a graphical user interface, through which the user can create and change a VPDC. In one implementation, the graphical user interface (shown for example in FIG. 2) is displayed on one or more computing devices 2 (such as computing devices 2a, 2b and 2n as shown in FIG. 1) wherein each computing device has sufficient processing unit power, memory, input/output capabilities and connectivity to display the graphical user interface, allow the user to interact with the computing device and interact with a back-end virtual private datacenter unit 4 over a link 3. Each computing device may have one or more processing units, memory and connectivity circuits and may be, for example, a laptop computer, a terminal computer, a mobile device and the like. In one embodiment, each computing device 2 may be executing a typical browser application that displays a graphical user interface 7 of the VPDC which is described in more detail below with reference to FIG. 2. The link 3 may be a wired or wireless link that allows the computing devices 3 and the unit 4 to communicate using a known protocol. For example, the system may be implemented using the Internet as the link and using the HTTP or SHTTP protocol for communications in one implementation.

The virtual private datacenter unit 4 may include a virtual private datacenter manager 5 that may be implemented as a plurality of lines of computer code being executed by a processing unit that is part of the computer system (such as server computer) that is used to implement the virtual private datacenter unit 4. The virtual private datacenter manager 5 may receive communications from each computing device, configure each virtual private datacenter for each user of each computing device, allocate hardware resources to each configured virtual private datacenter, handle changes to each virtual private datacenter and charge each user for their virtual private datacenter usage as appropriate. The virtual private datacenter manager 5 may also include a storage unit that stores icons and information about one or more virtual appliances and one or more virtual interconnections that can be used to model a virtual private datacenter as described below in more detail. The virtual private datacenter unit 4 may also have an associated hardware farm (physical datacenter) 6 from which the virtual private datacenter manager 5 can allocate hardware resources for each virtual private data center.

An example of the graphical user interface 7 of the virtual private datacenter system is shown in FIG. 2. The user uses the graphical user interface to add virtual appliances to a VPDC (virtual servers running any operating system (Windows, Linux, Solaris, BSD . . . ), virtual application servers running any application, virtual NAS appliances (file servers), virtual SAN appliances (providing network storage), virtual switches, virtual routers, virtual firewalls, virtual networks, bandwidth . . . ), to remove virtual appliances from the VPDC, to change values of parameters of virtual appliances which are in the VPDC as described below, to add interconnections and to remove interconnections wherein the types of interconnections are described below in more detail. In one embodiment, each type of virtual appliance is represented by a particular image and each interconnect is represented by a straight or curved line or any other type of visual representation of an interconnection. The image of each type of virtual appliance can be for example a drawing or a picture of an appliance such as a physical server, physical switch or any other type of drawing or picture. The system may also show the user a list of all available types of virtual appliances in a listing in one area of the graphical user interface and the user can select a virtual appliance type from the listing and add a virtual appliance of that particular type to the VPDC. In one implementation, this adding of virtual appliances may be visualized through a “drag & drop” concept or any other type of visualization.

Using the graphical user interface which updates the virtual private datacenter manager 5 over the link, the user can save the user's particular VPDC for later usage. The user can also visualize a VPDC which has been created at an earlier time and which has been saved for future usage.

Using the system, the user also can trigger the provisioning of a VPDC, which means that all resources of said VPDC will be provisioned in a physical datacenter from the hardware farm 6. The provisioning can be done by mapping all the elements of the requested VPDC to resources in a physical datacenter (or hardware farm 6) according to the methods described below. When the provisioning of the VPDC is completed, the resources of said VPDC are available for use by a group of users.

As shown in FIG. 2, the graphical user interface (GUI) 7 of the system allows a user to create and change a VPDC. The GUI may include a listing 21 of all available types of virtual appliances. The GUI may also have a visualization region 22 where the VPDC of the user is visualized. The listing 21 contains images of available virtual appliance types such as for example a virtual server 23, a virtual switch 24 and a virtual SAN 25. In the example shown in FIG. 2, the visualization region 22 shows a VPDC which comprises two virtual servers 26, 27, a virtual SAN 28, a virtual switch 32 and another virtual appliance 34. In the example, the virtual server 26 is interconnected with the virtual switch 32 through the network interconnection 29, the virtual server 27 is interconnected with the virtual switch 32 through the network interconnection 31, the virtual SAN 28 is interconnected with virtual server 27 through the storage connection 30 and the virtual switch 32 is interconnected to the virtual appliance 34 through the network interconnection 33. Using the system, a user can create a virtual private datacenter with various configurations and appliances and the example shown in FIG. 2 is merely illustrative of such as virtual private datacenter.

The VPDC in the visualization region 22 could be, for example, a virtual private datacenter environment comprising a Windows server 26 a Linux server 27 and a virtual SAN 28 where said virtual SAN provides storage to the Linux server 27. In addition, the Windows server 26 and the Linux server 27 are connected to a virtual switch 32 which in turn is connected to a virtual firewall appliance 34. When the user triggers the provisioning of this VPDC (by selecting provisioning in the graphical user interface), the system may provision for example the following resources in the physical datacenter: (i) a virtual or physical Windows machine and a virtual or physical Linux machine (e.g. using VMWare, Xen, VirtualBox or any other type of server virtualization or a physical server); (ii) a volume on a SAN which provides primary storage to the Linux machine; (iii) a virtual or physical firewall appliance; (iv) a VLAN which interconnects the Windows and Linux machine and the firewall.

Modeling Method

A method to model a virtual private datacenter (VPDC) and a method to map a VPDC to resources in a physical datacenter are disclosed. The VPDC is an environment which typically comprises certain virtual datacenter resources that may be used by a group of people. The virtual datacenter resources may be dedicated or shared and are typically configured remotely through a user interface. The VPDC is modeled using virtual appliances and interconnections between said virtual appliances as described above. A virtual appliance is an entity with a certain capacity and the capacity may be expressed in one or more capacity units. In one embodiment, so called “processing units” and so called “storage units” are defined wherein:
A processing unit (PU) is a unit for processing capacity. It may express a certain amount of CPU capacity, a certain amount of memory capacity or a combination of both.
A storage unit (SU) is a unit for storage capacity. It may express a certain amount of storage to store data.

A PU may be mapped to physical resources including but not limited to memory (expressed in, for example, megabytes) and CPU usage (expressed in, for example, megahertz). For example, one PU could be equal to the combination of 100 MB memory and 400 MHz CPU usage.

An SU may be mapped to physical resources including but not limited to storage capacity on disks or other storage devices (expressed in, for example, gigabytes). For example one SU could be equal to 1 GB of storage. Optionally, an SU may be mapped to storage with a certain redundancy level or a certain performance level or a combination of both. For example one SU could be equal to 100 GB of storage with a performance of 200 IOPS/TB and said SU could also be equal to 25 GB of storage with a performance of 5.000 IOPS/TB and said SU could also be equal to 10 GB of storage with a performance of 10.000 IOPS/TB. It will be clear to those skilled in the art that both performance and redundancy can be expressed in many ways. In the above example IOPS per TB (I/O operations per second and per terabyte of storage) is used to quantify performance.

A VPDC uses actual resources in one or more physical datacenters, but there is typically no direct relationship with the virtual datacenter resources made available as part of the VPDC and the datacenter resources of the physical datacenter, which are in use by said VPDC.

The resources made available by the VPDC may be mapped to resources in a physical datacenter. The virtual appliances of a VPDC may be mapped to virtual machines or physical servers or physical appliances in the physical datacenter. The virtual machines may include any type of virtual machines including but not limited to virtual machines running on top of a hypervisor such as for example VMWare virtual machines, Xen virtual machines and VirtualBox virtual machines.

Capacity Planning Method

A method to perform capacity planning is also disclosed. If capacity units are used to express the capacity of a virtual appliance of a VPDC, the capacity of resources in the physical datacenter may also be expressed using the same capacity units. For example if processing units (PU's) and storage units (SU's) are used, the same units may be used to express the processing capacity and storage capacity of each resource in the physical datacenter. The capacity planning may be done by performing the following processes for each virtual appliance of the VPDC: the first process consists of finding a suitable resource in the physical datacenter to which the virtual appliance may be mapped where the resource has free capacity which is equal to or larger than the capacity of the virtual appliance; and the second process consists of deducting the capacity needed for the virtual appliance from the free capacity of said resource.

Appliance Parameters

For each type of virtual appliance, one or more parameters may be defined and each parameter has a name and a value and the value may be for example a numerical value, a text value, a value chosen from a predefined list of values or any other type of values. The parameters may be mapped to capacity units (for example processing and storage units) or to other properties of a virtual appliance or to certain physical resources or to certain physical properties. A non-exhaustive list of parameters may include:

(a) for a virtual NAS or virtual SAN: storage size in GB, with possible values 100 GB, 200 GB . . . .

(b) for a virtual NAS or virtual SAN: storage redundancy, with possible values “normal”, “high” . . . .

(c) for any type of virtual appliance: size, with possible values “small”, “medium”, “large” . . . .

(d) for a virtual switch: number of virtual network ports, with possible values 1, 2, 3 . . . .

(e) For a virtual network appliance (switch, router, firewall or any other type of network appliance): bandwidth, with possible values 100 GB, 200 GB . . . or with possible values 1 Mbit/s, 2 Mbit/s . . . .

(f) For a virtual application server: number of users, with possible values 1, 2, 3 . . . .

In the above example of parameters, the parameters of examples (a), (b), (c) and (f) may be mapped to capacity units such as for example storage and processing units.

Interconnections

Various types of interconnections between virtual appliances may be defined, including but not limited to “network interconnections” and “storage interconnections”. A network interconnection may interconnect a virtual switch or virtual router with any type of virtual appliance, in order to express that a network connection exists between said virtual switch or virtual router and said virtual appliance. More generally, a network interconnection may also interconnect two or more virtual appliances of any type in order to express a network connection between said virtual appliances. Network interconnections may be mapped to VLAN's, physical networks, virtual networks using a backplane or any other type of physical interconnection or any other type of network interconnect in the physical datacenter.

A storage interconnection may interconnect a virtual SAN appliance with any type of virtual appliance, in order to express that said virtual SAN appliance will provide storage to said virtual appliance. Storage interconnections may be mapped to physical storage interconnections in the physical datacenter, or virtual storage interconnections in the physical datacenter. Storage interconnections may also be mapped to an assignment of a storage volume to a virtual server or physical server in the physical datacenter, where said volume resides on any type of storage including but not limited to DAS, NAS and SAN storage.

Other types of interconnections may be used to express any type of dependency between multiple entities. For example a “backup interconnect” can be defined which is used to interconnect a virtual appliance with a virtual backup server, in order to express that backups of said virtual appliance will be stored on said virtual backup server, where said backup server may be a NAS server, a virtual server or any other type of device.

Chargeback

A method to perform chargeback or billing of a VPDC is also part of the system. In particular, a price per time unit may be associated with each type of virtual appliance wherein the time unit can be for example one hour, one day, one month or any other type of time unit.

In addition, a price per time unit may be associated with each type of capacity unit. For example, if “processing units” (PU's) and “storage units” (SU's) are defined to model a VPDC, a price per time unit may be defined for one PU and for one SU.

A price per time unit may be associated with each possible value of each parameter which is associated to a virtual appliance. For example if a parameter named “redundancy” is defined for a virtual NAS appliance, with possible values “normal” and “high”, a price per time unit may be associated with value “normal” and a higher price per time unit may be associated with value “high”.

The price per time unit for one element of a VPDC may be calculated as the sum of all prices per time unit associated with said element. For example the price per time unit for a virtual appliance may be equal to the sum of: (i) the price per time unit associated with the type of said virtual appliance, (ii) the price per time unit associated with the capacity units of said virtual appliance, (iii) the price per time unit associated with the values of each parameter of said virtual appliance.

Thus, the total price per time unit for a VPDC may be calculated as the sum of the prices per time unit of all elements of said VPDC.

In the system, the price per time unit may be expressed in a monetary currency (for example USD, EUR . . . ) or as a number of one or more types of so called credits.

In one embodiment, three types of credits are defined: processing credits, network credits and storage credits. Examples: the price per time unit of a storage unit (SU) could be equal to 1 storage credit; the price per time unit of a processing unit (PU) could be equal to 1 processing credit; the price per time unit of a virtual appliance of type “virtual switch” could be equal to 1 networking credit; the price of the value “1 Mbit/s” of a parameter called “bandwidth” could be equal to 100 network credits.

Credits may in turn be associated with a certain cost expressed in a monetary currency. Credits may have a one time cost or a recurring cost (for example per hour, per day or per month) or a combination of both. For example a processing credit could have a cost of 1 USD per month.

While the foregoing has been with reference to a particular embodiment of the invention, it will be appreciated by those skilled in the art that changes in this embodiment may be made without departing from the principles and spirit of the invention, the scope of which is defined by the appended claims.

1. A virtual private datacenter system, comprising:
one or more computing devices;
a virtual private datacenter unit that is capable of interacting with the one or more computing devices, wherein the virtual private datacenter unit further comprises a virtual private datacenter manager that has a storage unit with one or more virtual appliances wherein each virtual appliance includes information about the particular virtual appliance and one or more interconnections wherein each interconnection includes information about the particular interconnection; and
wherein the virtual private datacenter manager models a virtual private datacenter requested by a particular computing device using the one or more virtual appliances and interconnections between the one or more virtual appliances.

2. The system of claim 1, wherein each computing device further comprises a browser application that displays a graphical user interface to model the virtual private datacenter wherein each virtual appliance has an associated icon.

3. The system of claim 2, wherein each of the one or more virtual appliances further comprise a virtual server, a physical server, a fileserver appliance (NAS), a virtual application server or a physical application server.

4. The system of claim 1 further comprises a physical datacenter having one or more appliances and wherein the virtual private datacenter manager maps each virtual appliance to an appliance in the physical datacenter to provision the virtual private datacenter.

5. The system of claim 4, wherein the virtual private datacenter manager charges a fee for the provisioned virtual private datacenter.

6. A virtual private datacenter method, comprising:
providing a virtual private datacenter manager that has a storage unit with one or more virtual appliances wherein each virtual appliance includes information about the particular virtual appliance and one or more interconnections wherein each interconnection includes information about the particular interconnection; and
modeling a virtual private datacenter requested by a user using the one or more virtual appliances and interconnections between the one or more virtual appliances.

7. The method of claim 6 further comprising displaying a graphical user interface on a computing device associated with the user that allows the user to model the virtual private datacenter wherein each virtual appliance has an associated icon.

8. The method of claim 6 further comprising provisioning the virtual private datacenter with the one or more virtual appliances and interconnections between the one or more virtual appliances using resources in a physical datacenter.

9. The method of claim 8, wherein provisioning the virtual private datacenter further comprises mapping one or more physical resources from the physical datacenter to the virtual private datacenter.

10. The method of claim 9, wherein mapping resources further comprises assigning a processing unit value or a storage unit value to each physical resource and assigning one or more parameters to each virtual appliances and mapping the one or more parameters of each virtual appliance to the processing unit value or storage unit value of the physical resources.

11. The method of claim 9 further comprising charging a user for using the virtual private datacenter wherein charging the user further comprises assigning one of a processing credit, a storage credit and a network credit to each virtual appliance and mapping a total of the credits associated with the one or more virtual appliances that are part of the virtual private datacenter to a price.

12. The method of claim 11, wherein the price further comprises a predetermined number of dollars per month.
